(19) United States
(12) Patent Application Publication
(10) Pub. No.: US 2012/0091009 A1
(43) Pub. Date: Apr. 19, 2012

(54) METHOD AND APPARATUS FOR PRODUCING NANO-SIZED SILVER PARTICLES USING ELECTROLYSIS

(75) Inventors: Min Young Choi, Gimpo-si (KR); Byung Sun Han, Gimpo-si (KR); Tae Gyun Kim, Gimpo-si (KR); Yong Sul Song, Seoul (KR)

(73) Assignee: AMOGREENTECH CO., LTD., Kimpo-si (KR)

(21) Appl. No.: 13/377,976

(22) PCT Filed: Jun. 14, 2010
(86) PCT No.: PCT/KR2010/003797

§ 371 Date: Dec. 13, 2011

(30) Foreign Application Priority Data
Jun. 15, 2009 (KR) 10-2009-0052937
Aug. 19, 2009 (KR) 10-2009-0076485

(51) Int. Cl. C25C 1/20; C25C 7/00; B82Y 99/00; B82Y 40/00

(52) U.S. Cl. 205/571; 204/212; 977/773; 977/899

(57) ABSTRACT

Provided is a method and apparatus for producing silver nanoparticles in uniform shape and size using an electrolysis eco-friendly and in a simple way. The silver nanoparticles producing method includes the steps of: dissolving a reducing agent and an electrolyte into water in a reaction vessel to thereby prepare an electrolytic solution; placing a cathode rod that is made of a material different from that of silver nanoparticles to be obtained in the electrolytic solution so as to rotate in the reaction vessel, and placing at least one anode made of silver (Ag) at a certain distance from the cathode rod; ionizing the silver at the anode by an electrolysis in which direct-current (DC) power is applied between the cathode rod and the anode while rotating the cathode rod, so as to suppress silver crystallines on the surface of the cathode rod while stirring the electrolytic solution, to thereby form silver ions in the electrolytic solution; and reducing the silver ions by the reducing agent to thereby form the silver nanoparticles.

### TECHNICAL FIELD

The present invention relates to a method and apparatus for producing silver nanoparticles, and more particularly to a method and apparatus for producing silver nanoparticles having a uniform shape and size in an eco-friendly and simple way using an electrolysis.

### BACKGROUND ART

In general, there are being used chemical methods such as a coprecipitation method, a spraying method, a sol-gel method, an electrolysis method, and a reverse phase micro-emulsion method, and mechanical methods such as a grinding method using a ball mill, or stamp mill, as methods of obtaining fine metal powder.

For example, for the chemical methods of producing silver powder, there are mainly used methods of educing silver powder through a method of reducing a precipitate of silver oxide or hydroxide that has been produced through a neutralization reaction process that neutralizes a silver nitrate aqueous with an alkaline solution, by use of a reducing agent such as hydrazine or hydrogen peroxide for the precipitate of silver oxide or hydroxide, and formaldehyde often known as formalin, a method of reducing the precipitate of silver hydroxide that has been produced through the neutralization reaction process by inhalation of a gas with a strong reduction force such as hydrogen or carbon monoxide into the precipitate of silver hydroxide, and a method of reducing an alkaline amino complex by addition of a reducing agent such as formaldehyde often known as formalin and oxalic acid into an alkaline amino complex aqueous solution.

However, since these conventional methods use a metallic salt of an electrolyte as a starting material, respectively, they are not environmentally friendly but are costly and time-consuming in order to remove harmful matter, and do not easily control size of particles.

In addition, since the conventional methods use a surfactant, an additive, or harmful matter in order to prevent particle growth due to aggregation of metal particles, they are not environmentally friendly.

In general, the conventional electric decomposition method called an electrolysis uses an electrode of a metallic material to be synthesized, and a metallic salt that is nitrate, carbonate, or sulfate as an electrolyte, in which the metallic material clings onto the surface of the electrode by the electrolysis, to thereby obtain metallic particles.

The reason why toxic metal salts are being used as electrolytes for obtaining metallic powder in the electrolysis is of course because metal is not soluble in water. Further, if metal combined with a strong acid salt is dissolved in water, it is easily dissociated into metal ions to then be educed into particles by reducing agents. In this case, harmful matter is produced as a by-product and noxious gases are generated when the temperature increases. Accordingly, the conventional electrolysis is not eco-friendly, nor obtains a uniform size of particles.

Moreover, in the case of the conventional electrolysis using a metallic salt that is nitrate, carbonate, or sulfate, the starting material is not only environmentally friendly in itself, but a waste water treatment problem also occurs in the neutralizing and washing processes. Further, a number of washing processes should undergo to thus cause a big burden, and a lot of metal powder is lost in the washing process.

Meanwhile, a method of grinding silver powder using a ball mill or stamp mill is widely used as a mechanical method of obtaining the silver powder. However, such a mechanically grinding method is essentially limited to miniaturization of the metal powder and is irrelevant to getting pure metal particles because of causing a possibility of contamination during the grinding process.

In order to consider and solve the problem that the starting material is not only environmentally friendly in itself, but a waste water treatment problem also occurs in the neutralizing and washing processes in the case of the conventional electrolysis using a metallic salt, a method of producing metal nanoparticles using an electrolysis was proposed in Korean Laid-open Patent Publication No. 10-2004-105914, in which only an electrode, a small amount of additives, and ultra-pure water (DI-water; DeIonized-water) are used and an external force is added in the electrolysis, to thus induce formation and dispersion of metal particles, and to thereby produce metal nanoparticles environmentally friendly.

The above-described conventional method of producing metal nanoparticles will be described below in detail.

As shown in FIG. 1, in the conventional method of producing metal nanoparticles, a solution 2 that is obtained by mixing an eco-friendly metal ion reducing agent or an organic metal ion reducing agent as an addictive into pure water is put into a vessel 1, and two electrode rods 3 are placed at a distance spaced from each other. In addition, an ultrasonic device 4 that emits ultrasonic waves into the solution 2 and an agitator 5 agitating the solution 2 are placed on the top and bottom of the vessel 2, respectively. Here, direct-current (DC) electric power is applied across the two electrode rods 3.

However, since the positive electrode rod called an anode and the negative electrode called a cathode are made of the same ingredients as those of the metal particles to be obtained in the above-descried Korean Laid-open Patent Publication No. 10-2004-105914, there occurred a phenomenon that metallic ions cling to and are crystallized on the electrode by a potential difference between the two electrode rods.

In addition, in the case of producing the metal nanoparticles, for example, silver nanoparticles by using the method disclosed in the Korean Laid-open Patent Publication No. 10-2004-105914, metal cations that have been produced at the anode move to the cathode when electric current is applied, to then grow to the neighboring portion of the cathode rod. Accordingly, micro-ordered silver particle crystallines exceeding nano-size are produced, to thereby cause a lumping phenomenon. Further, there have been problems that shape and size of metal particles are not uniform, and non-uniform particles are formed.

### DISCLOSURE

### Technical Problem

To solve the above problems or defects, it is an object of the present invention to provide a method and apparatus for producing silver nanoparticles in which silver ions (Ag⁺) that are produced by electrical energy are reduced into silver nanoparticles (Ag⁰) using a reducing agent before the silver ions (Ag⁺) are formed into crystallines at a cathode, a cathode rod is placed in a reaction vessel to prevent the silver ions (Ag⁺) that have not been reduced yet from growing up into the crystallines at the cathode rod, and the cathode rod is made to rotate to thereby minimize production of the crystallines and form uniform nano-sized particles.

It is another object of the present invention to provide a method and apparatus for producing silver nanoparticles in which cross-sections of a cathode rod and an anode is formed of a circular or elliptical shape, to prevent an electric flux line density from being concentrated between electrodes and to induce a uniform electric field, and material of the cathode rod is made of carbon, stainless steel or iron (Fe) different from that of the anode, to thereby minimize production of the crystallines at the cathode rod and form uniform nano-sized particles.

### Technical Solution

To accomplish the above and other objects of the present invention, according to an aspect of the present invention, there is provided a method of producing silver nanoparticles using an electrolysis, the silver nanoparticles producing method comprising the steps of:

dissolving a reducing agent and an electrolyte into water in a reaction vessel to thereby prepare an electrolytic solution;

placing a cathode rod that is made of a material different from that of silver nanoparticles to be obtained in the electrolytic solution so as to rotate in the reaction vessel, and placing at least one anode made of silver (Ag) at a certain distance from the cathode rod;

ionizing the silver at the anode by the electrolysis in which direct-current (DC) power is applied between the cathode rod and the anode while rotating the cathode rod, to thereby form silver ions in the electrolytic solution; and

reducing the silver ions by the reducing agent to thereby form the silver nanoparticles.

According to another aspect of the present invention, there is provided an apparatus for producing silver nanoparticles using an electrolysis, the silver nanoparticles producing apparatus comprising:

a cathode rod that is placed in an electrolytic solution within a reaction vessel so as to rotate in the reaction vessel and made of a material different from that of silver nanoparticles to be obtained;

at least one anode made of silver at a certain distance from the cathode rod; and

an electrode support housing that supports the cathode rod and the anode in an insulating form, and that has a negative terminal and a positive terminal that are externally exposed so that electric power is applied between the cathode rod and the anode for performing the electrolysis.

Preferably but not necessarily, the cathode rod is placed at a substantially central portion of the reaction vessel so as to rotate, and the silver nanoparticles producing apparatus further comprises a driving unit for rotating the cathode electrode that is connected to the cathode rod.

Preferably but not necessarily, the cathode rod is made of any one of carbon, stainless steel (SUS 316), iron (Fe).

Preferably but not necessarily, the cathode rod is also formed of an inverted truncated cone structure, a rod shape, or an elliptical rod shape.

Preferably but not necessarily, the anode is formed of a plate shape or a rod shape of metal.

Preferably but not necessarily, the reducing agent is an organic ion reducing agent, and the electrolyte is citric acid or amino acid.

Preferably but not necessarily, the silver nanoparticles producing apparatus according to the present invention further comprises a driving unit for rotating the cathode electrode that is connected to the cathode rod, and an electromagnetic driven agitator for agitating the electrolytic solution, in which a rotation direction of the agitator is set to be the opposite direction to that of the cathode rod.

In the case that the electrolysis is executed at a non-rotating state, the silver nanoparticles that are obtained in the present invention have an average size of 100 nm, and show an excellent uniformity of the particles. In the case that size of the silver nanoparticles exceeds 100 nm, for example, increases up to 200 nm, a sintering temperature should be heightened to 150° C. or higher that influences upon an insulation film when a conductive pattern is formed on an insulating film with a conductive ink using the size of the silver nanoparticles. Accordingly, the size of the silver nanoparticles is set so as not to exceed 100 nm.

In addition, in the case that the electrolysis is executed while the cathode is made to rotate at 1750 rpm or more, the silver nanoparticles that are obtained in the present invention have an average size of 50 nm, and show a very excellent uniformity of the particles, so as to be suitable for mass production. In this case, a rotating condition of the cathode rod that can obtain circular, uniform and average 50 nm-sized particles is to make the cathode rod rotate at at least 1750 rpm or more. Even in the case that the cathode rod is made to rotate at 6000 rpm or more in excess of 3000 rpm, the average size of particles is maintained at 50 nm or so but do not become smaller than 50 nm or so. However, it is undesirable to make the cathode rotate at high speed since such a high speed rotation of the cathode additionally requires a high speed driving motor and a structure of transmitting a rotating force of the driving motor to thus maintain a stable rotating number (rpm) structure.

### Advantageous Effects

As described above, in a method and apparatus for producing silver nanoparticles according to the present invention, silver ions (Ag⁺) that are produced by electrical energy are reduced into silver nanoparticles (Ag⁰) using an eco-friendly reducing agent before the silver ions (Ag⁺) are formed into crystallines at a cathode, a cathode rod is placed at the center of an agitator in a reaction vessel to prevent the silver ions (Ag⁺) that have not been reduced yet from growing up into the crystallines at the cathode rod, and the agitator and the cathode rod are made to rotate to thereby form a vortex, to thereby minimize production of the crystallines and form uniform nano-sized particles.

In addition, in a method and apparatus for producing silver nanoparticles according to the present invention, a material of a cathode rod is different from that of a silver anode so that silver crystallines do not grow at the cathode in a lumping form, a vortex is formed using an agitator, and the cathode rod is made to rotate to suppress growth of crystallines, to thereby form uniform nano-sized silver particles.

### DESCRIPTION OF DRAWINGS

FIG. 1 is a schematic diagram of a conventional metal nanoparticles producing apparatus.

FIGS. 2 and 3 are schematic diagrams illustrating a silver nanoparticles producing apparatus for describing silver nanoparticles producing method using an electrolysis according to an embodiment of the present invention.

FIG. 4 shows a FE-SEM (Field Emission Scanning Electron Microscope) picture of silver nanoparticles that are obtained by conducting an electrolysis using a carbon rod as a cathode rod according to the present invention.

FIGS. 5 through 10 respectively show FE-SEM (Field Emission Scanning Electron Microscope) pictures of silver nanoparticles that are obtained by conducting an electrolysis while varying a rotating speed of a carbon rod used as a cathode rod according to the present invention.

FIGS. 11 and 12 respectively show FE-SEM (Field Emission Scanning Electron Microscope) pictures of silver nanoparticles that are obtained by conducting an electrolysis without varying a rotating speed of a stainless steel or iron (Fe) rod used as a cathode rod according to the present invention.

FIGS. 13 through 16 respectively show FE-SEM (Field Emission Scanning Electron Microscope) pictures of silver nanoparticles that are obtained by conducting an electrolysis using a silver (Ag), aluminum (Al), bronze, or copper (Cu) rod as a cathode rod according to the present invention.

FIG. 17 shows FE-SEM (Field Emission Scanning Electron Microscope) pictures of silver nanoparticles that are obtained according to lapse of time by conducting an electrolysis using silver plates as both an anode and a cathode according to the conventional art.

FIG. 18 is a configurational diagram illustrating the entire configuration of a silver nanoparticles producing apparatus according to the present invention.

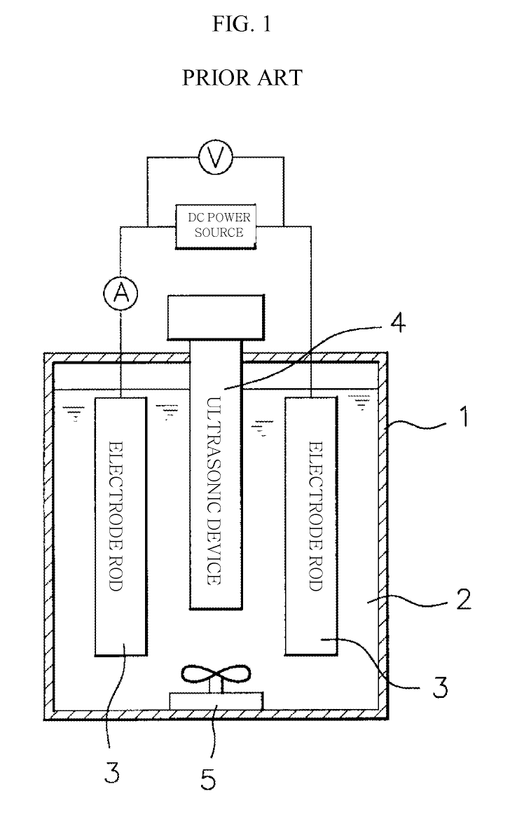

### BEST MODE

The above and/or other objects and/or advantages of the present invention will become more apparent by the following description. Hereinbelow, a silver nanoparticles producing apparatus according to a respective embodiment of the present invention will be described in detail with reference to the accompanying drawings.

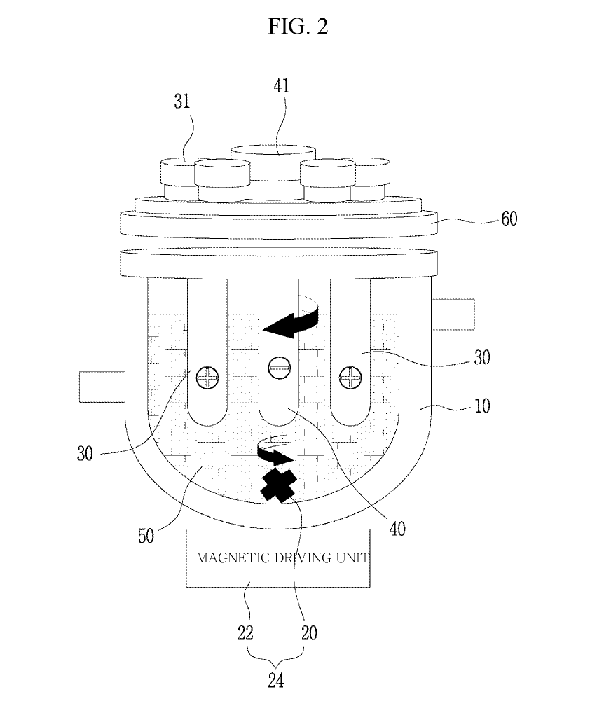

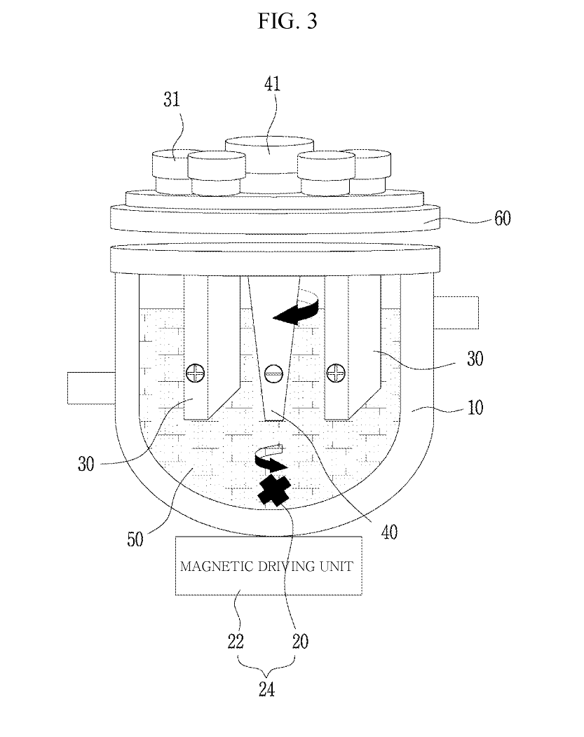

FIGS. 2 and 3 are schematic diagrams illustrating a silver nanoparticles producing apparatus for describing silver nanoparticles producing method using an electrolysis according to an embodiment of the present invention.

Referring to FIGS. 2 and 3, a silver nanoparticles producing apparatus using an electrolysis according to an embodiment of the present invention includes a reaction vessel 10 that is filled with an electrolytic solution 50 that is formed by mixing water such as ultra-pure water with an addictive, and anodes 30 made of silver and a cathode rod 40 made of a material different from silver that are disposed so as to be spaced apart from one another in the reaction vessel 10. An agitator 24 for stirring the electrolytic solution 50 is selectively placed at the lower portions of the anode 30 and the cathode rod 40, respectively.

The cathode rod 40 is preferably placed at the center of the reaction vessel 10 and the anode 30 is placed at the outer edge of the cathode rod 40. The number of the anodes may be one or more. In this case, the cathode rod 40 is preferably formed of a rod shape, an inverted truncated cone structure, or an elliptical rod shape in its cross-section. It is further preferable if the cathode rod 40 is formed of a shape that is suitable for forming vortex in the electrolytic solution 50. A material capable of preventing silver ions from the anode 30 from being adsorbed and growing on the cathode rod 40 thereby minimizing production of crystallines, for example, carbon, stainless steel (e.g. SUS 316), or iron (Fe) can be used as a material of the cathode rod 40. Moreover, it is desirable that the cathode rod 40 is rotatably placed so as to prevent the silver ions from being crystallized on the surface of the cathode rod 40.

It is preferable that the anode 30 is formed of a rod shape or a plate shape as shown in FIG. 3.

In addition, an electrode support housing 60 for supporting electrodes is combined with the upper portion of the reaction vessel 10. The electrode support housing 60 supports the anode 30 and the cathode rod 40 in an insulating form and is connected with the anode 30 and the cathode rod 40. An external electric power source (not shown) for applying a direct-current (DC) voltage for an electrolysis to a positive terminal 31 and a negative terminal 41 from the outside of the reaction vessel 10 is connected to the positive terminal 31 and the negative terminal 41.

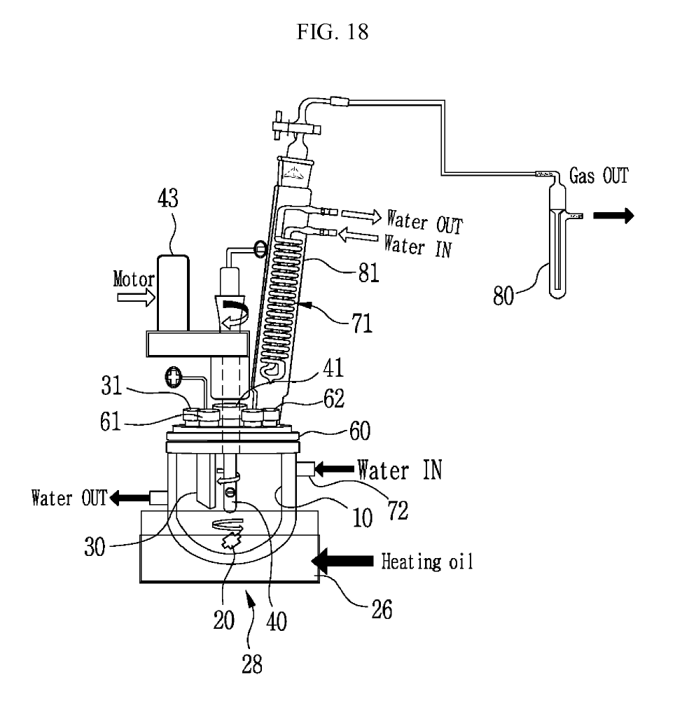

FIG. 18 illustrates a silver nanoparticles producing apparatus according to a preferred embodiment of the present invention. In FIG. 18, the same components as those of FIG. 2 are assigned with the same reference numbers as those of FIG. 2, and a detailed description thereof will be omitted.

The silver nanoparticles producing apparatus shown in FIG. 18 uses a silver (Ag) plate as the anode 30, and a carbon rod as the cathode rod 40, as an example. The upper portion of the cathode rod 40 is rotatably supported at the electrode support housing 60 that is coupled to the top of the reaction vessel 10.

The respective one end of the anode 30 and the cathode rod 40 is connected to the positive terminal 31 and the negative terminal 41 in the electrode support housing 60. The cathode rod 40 and the negative terminal 41 are rotatably driven by an electric motor 43 that is a rotational driving unit.

In addition, the electrode support housing 60 includes a sample inlet 61 for putting the sample into the reaction vessel 10 from the outside of the reaction vessel 10, and an exhaust gas outlet 62 for discharging reaction gas generated from the inside of the reaction vessel 10 during the electrolysis. Moreover, the silver nanoparticles producing apparatus shown in FIG. 18 includes a condenser 81 having a water cooling unit 71 to prevent evaporation of water that is a reaction solution during the reaction, and an indicator 80 that is connected to the condenser 81 and indicates generation of the exhaust gas.

A heating device 28 using a heating coil 26 for indirectly heating an electrolytic solution 50 is disposed at the lower portion of the reaction vessel 10, and a water cooling unit 72 that makes water flowing in the reaction vessel 10 to thus maintain a constant temperature of the electrolytic solution 50 is disposed at the outer side of the reaction vessel 10.

The electrolytic solution 50 is preferably made by adding an electrolyte, a reducing agent and a dispersing agent as an additive to ultra-pure water (DI-water) and mixing the former with the latter. The reducing agent is an eco-friendly reducing agent such as an organic ion reducing agent, for example, hydrazine. During the reaction, the organic ion reducing agent is all consumed to generate nitrogen gas and water. Accordingly, the organic ion reducing agent is not hazardous after completion of the reaction.

In addition, the electrolyte used in the present invention is an environmentally friendly electrolyte. A citric acid can be used as the electrolyte. As necessary, an amino acid such as glycine may be used as the electrolyte. In other words, the present invention uses the eco-friendly electrolyte and the eco-friendly organic ion reducing agent, instead of the electrolyte that is harmful to the environment, to thus get eco-friendly silver nanoparticles. In addition, the dispersing agent used in the present invention includes polyvinylpyrrolidone (PVP), poloxamer 407 or poloxamer 188.

In the present invention, ultra-pure water is preferably used as a solvent for making the electrolytic solution. Here, the ultra-pure water is tertiary distilled water and stands for deionized water having little anions and cations that exist in tap water or bottled water.

In the case that anions and cations that are impurities other than the environmentally friendly electrolyte and the organic ion reducing agent are mixed when manufacturing silver nanoparticles, impurities may be generated in the silver nanoparticles, and complex compounds may be produced. As a result, silver nanoparticles may not be efficiently obtained. Thus, it is good to use pure water, in particular, ultra-pure water as a solvent for making the electrolytic solution.

In addition, the amount of the reducing agent is put into the reaction vessel 10 within a range of 2.0 mmol to 20.0 mmol. Nanoparticles can be determined by a reaction time and temperature.

In general, metal atoms require energy to break metallic bonds to then become ionized. The energy for breaking metallic bonds to then become ionized is weak under a low voltage, and thus no reaction happens. However, when a high voltage is applied between the electrodes so as to exceed the bonding energy of the metallic bonds, ions flush out into the solution.

In the present invention, when a high voltage of the bonding energy or more is applied to the anode 30 from the electric power source (not shown), silver ions (Ag⁺) coming out of the anode 30 are reduced into silver nanoparticles by the reducing agent, or move toward the cathode rod 40 by an electrostatic attraction force, to thereby obtain electrons to then become silver crystallines.

Referring to FIGS. 2 and 3, as described above, when a high voltage of the bonding energy or more is applied to the anode 30 from the electric power source (not shown), silver ions (Ag⁺) dissolved in and coming out of the anode 30 move toward the cathode rod 40 by an electrostatic attraction force.

The moved silver ions (Ag⁺) gain electrons (e⁻) to then be produced into particles. Here, if the electrolytic solution 50 is agitated via the agitator 20 to prevent silver ions (Ag⁺) from staying at the cathode rod 40, the silver ions (Ag⁺) toward the cathode rod 40 are prevented from staying at the negative electrode by the agitator 24, to accordingly obtain small- and uniform-sized silver nanoparticles efficiently.

In other words, silver ions (Ag⁺) that are dissolved and coming out of the silver (Ag) anode 30 by the electrical energy are reduced into silver nanoparticles (Ag⁰) by a reducing agent in the electrolytic solution 50 before they grow into crystallines at the cathode rod 40, and the electrolytic solution 50 is stirred by the agitator 24 to prevent the silver ions (Ag⁺) that have not been reduced yet from growing at the cathode rod 40.

Stirring of the electrolytic solution 50 is achieved by an electromagnetic rotation of the agitator 24 in which a magnet piece 20 that is placed in the inside of the reaction vessel 10 is driven by a magnetic driving unit 22 that is placed at the lower portion of the reaction vessel 10.

When the electrolytic solution 50 is stirred using the agitator 24, the cathode rod 40 is made to rotate simultaneously with the rotation of the agitator 24, to thereby generate a vortex such as a turbulence. In this case, for example, the magnet piece 20 of the agitator 24 is made to rotate in the counterclockwise direction, and the cathode rod 40 is made to rotate in the clockwise direction, to thereby make the magnet piece 20 of the agitator 24 and the cathode rod 40 rotate in the opposite directions to each other and to thus maximize formation of the vortex and accelerate production of nanoparticles. The formation of the vortex in the electrolytic solution 50 prevents aggregation of the silver particles in the solution and crystallization of the silver particles into metallic crystallines on the surface of the cathode rod 40, and enables ions to easily move to form uniform nanoparticles.

In general, when a high voltage of the bonding energy or more of metallic atoms is applied between the two electrodes during execution of the electrolysis, the metallic atoms of the anode break off the metallic bonds and flush out in the form of metallic cations in the electrolytic solution to thus become positively ionized. These cations move to the cathode by an electrostatic attraction force formed between the anode and the cathode, and gain electrons from the cathode to then be produced into particles and educed into crystallines.

In the case of producing metal nanoparticles via an electrolysis, a phenomenon that an electric flux line density is concentrated to a particular portion between anode and cathode electrodes causes cations to be focused into a certain portion of the cathode having the high electric flux line density. Such a phenomenon is undesirable in order to produce uniform nanoparticles.

Thus, if the cathode rod 40 is formed of a rod shape or an inverted truncated cone shape, or is formed of an elliptical shape in its cross-section, a phenomenon that an electric flux line density is concentrated to a particular portion between anode and cathode electrodes can be prevented, and a uniform electric field can be induced all over the whole outer surface of the cathode rod 40.

Hereinafter, the present invention will be described in greater detail through examples. These examples merely illustrate the present invention and it would not be understood that the scope of the invention is limited by the examples.

### Example 1

### Non-Rotational Experiment

As in an electrolysis apparatus shown in FIG. 18, an anode electrode made of a single silver plate and a cathode electrode made of a carbon rod were disposed at a distance spaced from each other in an electrode support housing. Here, the cathode electrode was rotatably placed at the center of the electrode support housing, and connected to an electric motor for driving by rotation in a reaction vessel. An agitator using a magnet piece was placed in the inside of the reaction vessel. Accordingly, the reaction vessel was configured to undergo an effect of a vortex phenomenon caused by the agitator.

After the anode and cathode electrodes had been completely placed, additives such as ultrapure water (DI-water) of 1 L and citric acid of 2.0 mmol as an electrolyte, hydrazine of 10.0 mmol as a reducing agent, and poloxamer 407 of 2.0 g as a dispersing agent were put into the reaction vessel, respectively, and stirred using the agitator until they were completely dissolved in the reaction vessel.

An aqueous solution into which all the additives had been dissolved was heated to maintain the temperature of the aqueous solution to be at 90° C. Then, the cathode electrode formed of a cathode rod was not made to rotate and a direct current (DC) voltage of 200V was applied between the anode and cathode electrodes. When applying the DC voltage between the anode and cathode electrodes, an electrical resistance was created due to the electrolyte that is present in the aqueous solution, thus generating heat. Accordingly, a steady stream of cooling water was made to flow in the reaction vessel, so as to keep the reaction to proceed at a constant temperature for one hour.

During the course of an electrolysis, water was electrically decomposed to thus generate hydrogen and oxygen gases. It was ascertained that the generated gases went out, using an indicator connected with the reaction vessel.

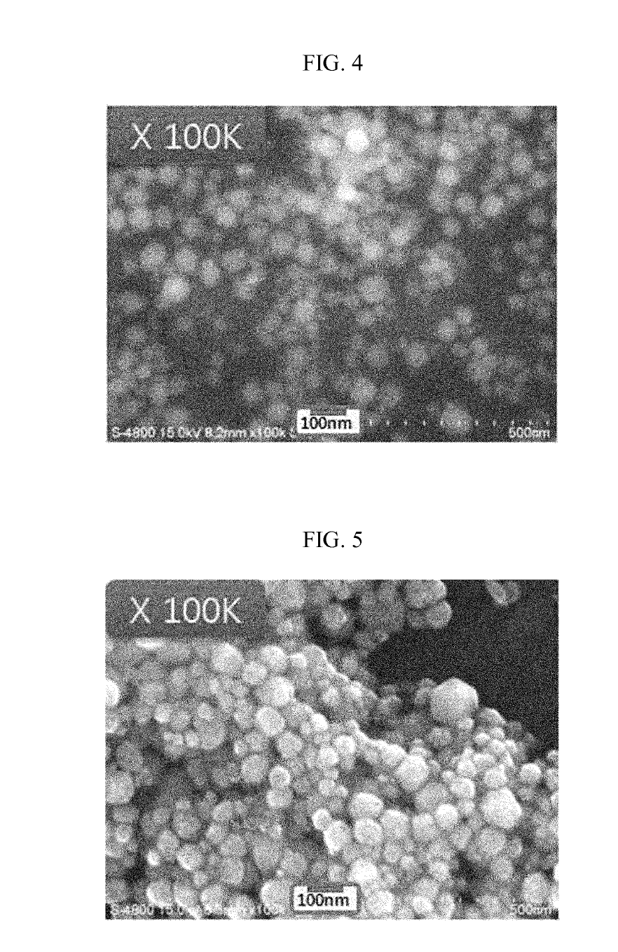

Silver nanoparticles having existed in an aqueous solution obtained after electrical decomposition for one hour were analyzed by FE-SEM (Field Emission Scanning Electron Microscope). In the analytical results, as illustrated in FIG. 4, size of the obtained silver nanoparticles was average 100 nm, uniformity of the silver nanoparticles was somewhat low, and shape of the silver nanoparticles was a polygonal shape. However, it was found that no particles had grown.

### Example 2

### Rotational Experiment at 1,000 rpm

In Example 2, a carbon rod corresponding to a cathode electrode was made to rotate at 1,000 rpm, and undergo an electrolysis for one hour under the same conditions as those of Example 1.

An aqueous solution obtained after electrical decomposition via the electrolysis was analyzed by FE-SEM (Field Emission Scanning Electron Microscope). In the analytical results, as illustrated in FIG. 5, size of the silver nanoparticles was average 100 nm, uniformity of the silver nanoparticles was revealed to be more excellent than that of Example 1, and shape of the silver nanoparticles was a polygonal shape. However, it was found that no particles had grown.

### Example 3

### Rotational Experiment at 1,250 rpm

In Example 3, a carbon rod corresponding to a cathode electrode was made to rotate at 1,250 rpm, and undergo an electrolysis for one hour under the same conditions as those of Example 1.

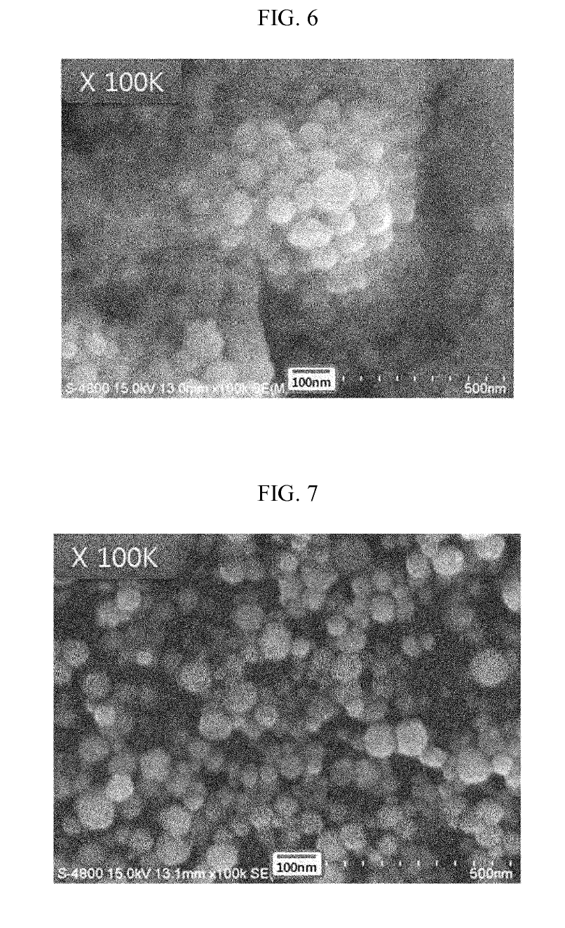

An aqueous solution obtained after electrical decomposition via the electrolysis was analyzed by FE-SEM (Field Emission Scanning Electron Microscope). In the analytical results, as illustrated in FIG. 6, size of the silver nanoparticles was average 100 nm, uniformity of the silver nanoparticles was revealed to be more excellent than that of Example 2, and shape of the silver nanoparticles was a polygonal shape. However, it was found that no particles had grown.

### Example 4

### Rotational Experiment at 1,500 rpm

In Example 4, a carbon rod corresponding to a cathode electrode was made to rotate at 1,500 rpm, and undergo an electrolysis for one hour under the same conditions as those of Example 1.

An aqueous solution obtained after electrical decomposition via the electrolysis was analyzed by FE-SEM (Field Emission Scanning Electron Microscope). In the analytical results, as illustrated in FIG. 7, size of the silver nanoparticles was average 100 nm, uniformity of the silver nanoparticles was revealed to be more excellent than that of Example 3, and shape of the silver nanoparticles existed as both a polygonal shape and a circular shape. However, it was found that no particles had grown.

### Example 5

### Rotational Experiment at 1,750 rpm

In Example 5, a carbon rod corresponding to a cathode electrode was made to rotate at 1,750 rpm, and undergo an electrolysis for one hour under the same conditions as those of Example 1.

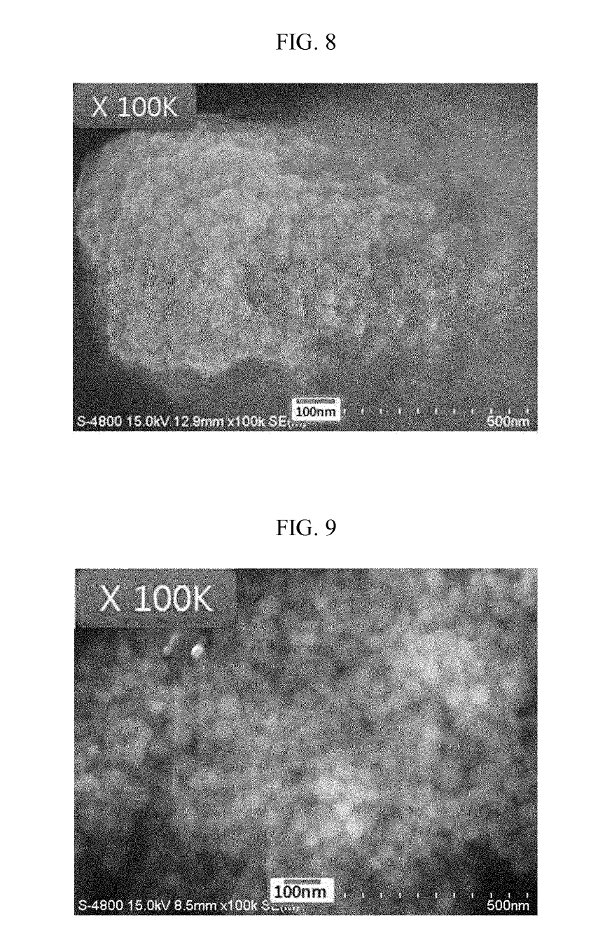

An aqueous solution obtained after electrical decomposition via the electrolysis was analyzed by FE-SEM (Field Emission Scanning Electron Microscope). In the analytical results, as illustrated in FIG. 8, size of the silver nanoparticles was average 50 nm, uniformity of the silver nanoparticles was revealed to be much more excellent than that of Example 4, and shape of the silver nanoparticles was a circular shape mostly. However, it was found that no particles had grown.

### Example 6

### Rotational Experiment at 2,000 rpm

In Example 6, a carbon rod corresponding to a cathode electrode was made to rotate at 2,000 rpm, and undergo an electrolysis for one hour under the same conditions as those of Example 1.

An aqueous solution obtained after electrical decomposition via the electrolysis was analyzed by FE-SEM (Field Emission Scanning Electron Microscope). In the analytical results, as illustrated in FIG. 9, size of the silver nanoparticles was average 50 nm, uniformity of the silver nanoparticles was revealed to be similar to that of Example 5, and shape of the silver nanoparticles was a circular shape mostly. However, it was found that no particles had grown.

### Example 7

### Rotational Experiment at 3,000 rpm

In Example 7, a carbon rod corresponding to a cathode electrode was made to rotate at 3,000 rpm, and undergo an electrolysis for one hour under the same conditions as those of Example 1.

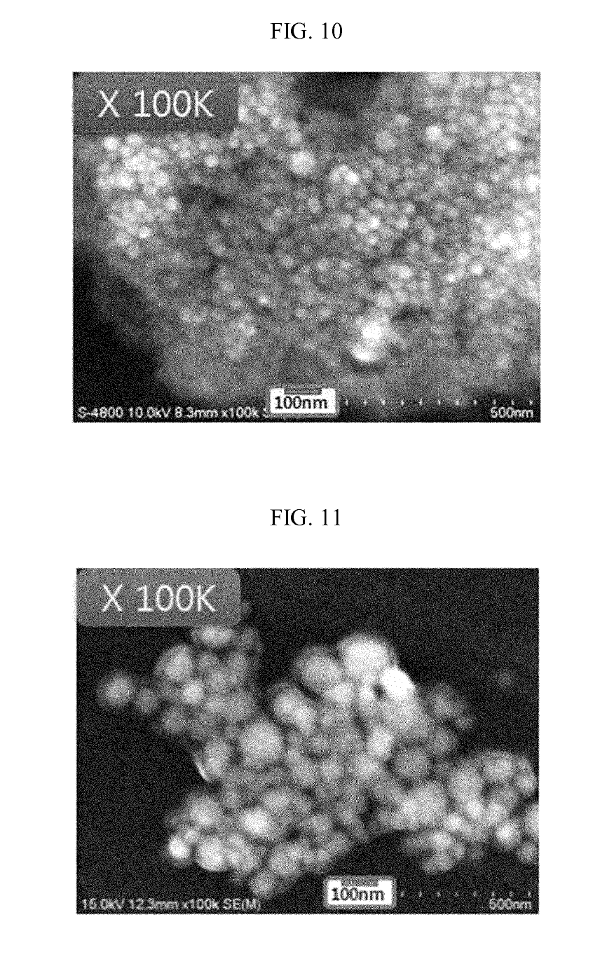

An aqueous solution obtained after electrical decomposition via the electrolysis was analyzed by FE-SEM (Field Emission Scanning Electron Microscope). In the analytical results, as illustrated in FIG. 10, size of the silver nanoparticles was average 50 nm, uniformity of the silver nanoparticles was revealed to be similar to that of Example 5, and shape of the silver nanoparticles was a circular shape mostly. However, it was found that no particles had grown.

### Example 8

### Use of a Stainless Steel (SUS 316) Rod as a Cathode

Example 8 was made to undergo an electrolysis under the same conditions as those of Example 1, except that a stainless steel (SUS 316) rod was used instead of a carbon rod corresponding to a cathode electrode.

An aqueous solution obtained after electrical decomposition via the electrolysis was analyzed by FE-SEM (Field Emission Scanning Electron Microscope). In the analytical results, as illustrated in FIG. 11, size of the silver nanoparticles was uniform as average 100 nm or less, and shape of the silver nanoparticles was close to an angularly elliptical shape rather than a circular shape However, it was found that no crystalline particles had grown.

### Example 9

### Use of an Iron (Fe) Rod as a Cathode

Example 9 was made to undergo an electrolysis under the same conditions as those of Example 2, except that an iron (Fe) rod was used instead of a carbon rod corresponding to a cathode electrode.

An aqueous solution obtained after electrical decomposition via the electrolysis was analyzed by FE-SEM (Field Emission Scanning Electron Microscope). In the analytical results, as illustrated in FIG. 12, size of the silver nanoparticles was uniform as average 100 nm or less, and shape of the silver nanoparticles was a circular shape However, it was found that no crystalline particles had grown.

### Comparative Example 1

### Use of a Silver (Ag) Rod as a Cathode

Comparative Example 1 was made to undergo an electrolysis under the same conditions as those of Example 1, except that a silver (Ag) rod was used instead of a carbon rod corresponding to a cathode electrode.

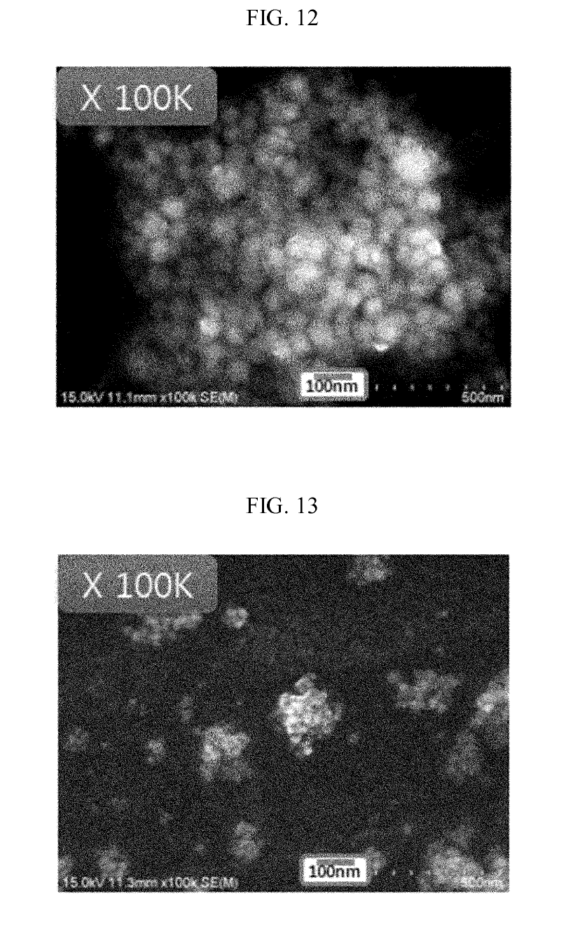

It was ascertained that crystallines were growing at the Ag cathode rod during the course of the electrolysis. Accordingly, the electrolysis was in progress only for five minutes and then stopped. In the result of performing an analysis through FE-SEM (Field Emission Scanning Electron Microscope), as illustrated in FIG. 13, size of the silver nanoparticles was average 100 nm, and it was found that most of particles had grown, although the reaction time was short.

### Comparative Example 2

### Use of an Aluminum (Al) Rod as a Cathode

Comparative Example 2 was made to undergo an electrolysis under the same conditions as those of Example 1, except that an aluminum (Al) rod was used instead of a carbon rod corresponding to a cathode electrode.

It was ascertained that crystallines were growing at the Al cathode rod during the course of the electrolysis. Accordingly, the electrolysis was in progress only for twenty minutes and then stopped. In the result of performing an analysis through FE-SEM (Field Emission Scanning Electron Microscope), as illustrated in FIG. 14, size of the silver nanoparticles was average 200 nm or less, and it was found that most of particles had grown.

### Comparative Example 3

### Use of a Bronze Rod as a Cathode

Comparative Example 3 was made to undergo an electrolysis under the same conditions as those of Example 1, except that a bronze rod was used instead of a carbon rod corresponding to a cathode electrode.

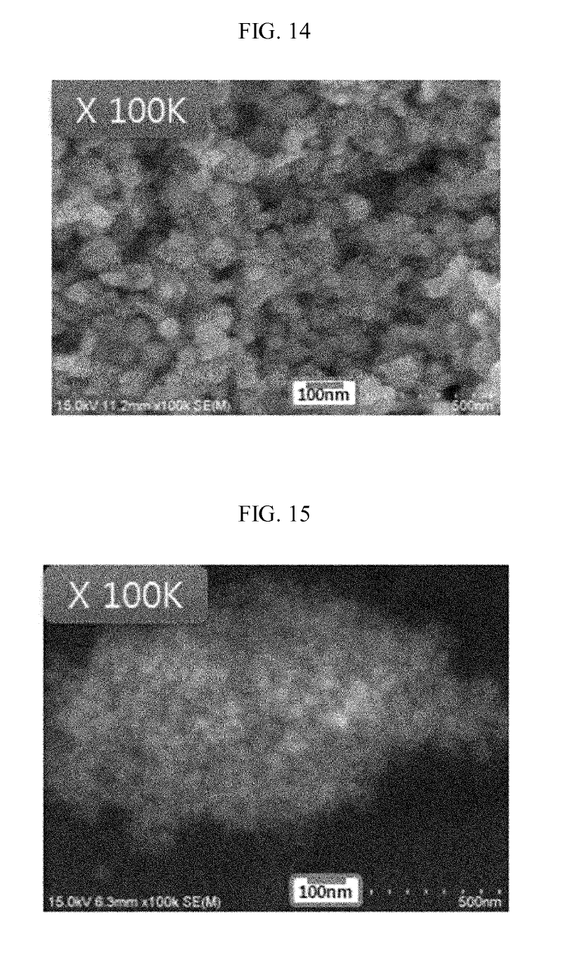

It was ascertained that crystallines were growing at the bronze cathode rod corresponding to the cathode during the course of the electrolysis. Then, the electrolysis was in progress for one hour. In the result of performing an analysis through FE-SEM (Field Emission Scanning Electron Microscope), as illustrated in FIG. 15, the silver nanoparticles existed as both silver particles of average 100 nm and silver particles that had grown.

### Comparative Example 4

### Use of a Copper (Cu) Rod as a Cathode

Comparative Example 4 was made to undergo an electrolysis under the same conditions as those of Example 1, except that a copper (Cu) rod was used instead of a carbon rod corresponding to a cathode electrode.

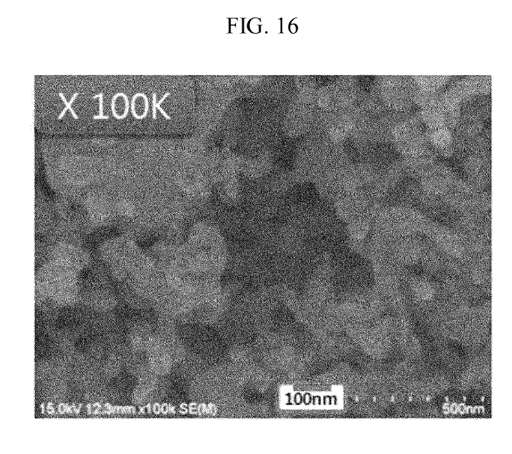

It was ascertained that crystallines were growing at the Cu cathode rod corresponding to the cathode during the course of the electrolysis. Then, the electrolysis was in progress for one hour. In the result of performing an analysis through FE-SEM (Field Emission Scanning Electron Microscope), as illustrated in FIG. 16, it was found that the silver nanoparticles existed as both particles that had grown into big size and particles of 200 nm or less.

### Comparative Example 5

### Use of a Silver (Ag) Plate as a Cathode

In Comparative Example 5, an anode electrode made of a silver plate and a cathode electrode made of a silver plate were disposed at a distance spaced from each other in an electrode support housing. The anode electrode and the cathode electrode were placed in a reaction vessel. An agitator using a magnet piece was placed in the inside of the reaction vessel. Accordingly, the reaction vessel was configured to undergo an effect of a vortex phenomenon caused by the agitator. In this manner, an electrolysis apparatus was constructed.

After the anode and cathode electrodes had been completely placed, additives such as ultrapure water (DI-water) of 1 L and citric acid of 2.0 mmol as an electrolyte, hydrazine of 10.0 mmol as a reducing agent, and polyvinylpyrrolidone (PVP) of 2.0 g as a dispersing agent were put into the reaction vessel, respectively, and stirred using the agitator until they were completely dissolved in the reaction vessel. An aqueous solution in which all additives had dissolved is heated to maintain the solution temperature at 90° C., and then a direct current (DC) voltage of 200V was applied between the anode and cathode electrodes. In this case, the cathode electrode was not made to rotate.

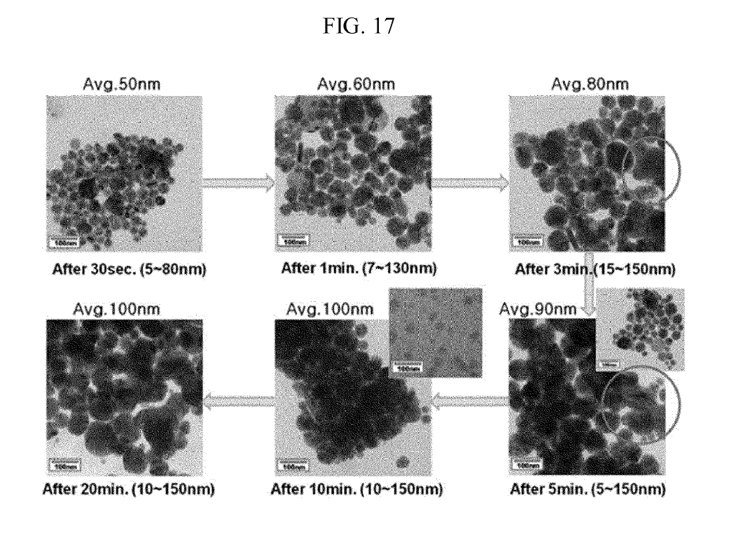

During the course of an electrolysis, test samples were obtained at points in time of 30 seconds, 1 minute, 3 minutes, 5 minutes, 10 minutes, and 20 minutes, respectively. Silver nanoparticles existing in solutions obtained as the test samples had analyzed through FE-SEM (Field Emission Scanning Electron Microscope). In the result of performing an analysis through FE-SEM (Field Emission Scanning Electron Microscope), as illustrated in FIG. 17, it was ascertained that crystallines were growing at the cathode electrode. According to lapse of time, it was found that particles had grown and particles of various sizes of 15-150 nm were mixed even at a point in time of 3 minutes or so.

The results of Examples 1-9 and Comparative Examples 1-5 have been summarized in the following Table 1.

TABLE 1

| | | | | | Size of | | | |
|---|---|---|---|---|---|---|---|---|
| | | | Rotational | Reaction | Particles | Uniformity | Growth of | Mass-production |
| | Anode | Cathode | Cathode | time | (nm) | of Particles | Particles | Adaptability |
| Example 1 | Ag plate | Carbon | Non-rotation | 1H | 100 | ◯ | X | ⊚ |
| | | rod | | | | | | |
| Example 2 | Ag plate | Carbon | 1,000 rpm | 1H | 100 | ◯ | X | ⊚ |
| | | rod | | | | | | |
| Example 3 | Ag plate | Carbon | 1,250 rpm | 1H | 100 | ◯ | X | ⊚ |
| | | rod | | | | | | |
| Example 4 | Ag plate | Carbon | 1,500 rpm | 1H | 100 | ◯ | X | ⊚ |
| | | rod | | | | | | |
| Example 5 | Ag plate | Carbon | 1,750 rpm | 1H | 50 | ⊚ | X | ⊚ |
| | | rod | | | | | | |
| Example 6 | Ag plate | Carbon | 2,000 rpm | 1H | 50 | ⊚ | X | ⊚ |
| | | rod | | | | | | |
| Example 7 | Ag plate | Carbon | 3,000 rpm | 1H | 50 | ⊚ | X | ⊚ |
| | | rod | | | | | | |
| Example 8 | Ag plate | SUS 316 | Non-rotation | 1H | 100 | ◯ | X | ◯ |
| | | rod | | | | | | |
| Example 9 | Ag plate | Fe rod | Non-rotation | 1H | 100 | ◯ | X | ⊚ |
| Comparative | Ag plate | Ag rod | Non-rotation | 5 min | 100 | XX | ⊚ | XX |
| Example 1 | | | | | | | | |
| Comparative | Ag plate | Al rod | Non-rotation | 20 min | 200 | X | ⊚ | XX |
| Example 2 | | | | | | | | |
| Comparative | Ag plate | Bronze | Non-rotation | 1H | 100 | X | ◯ | X |
| Example 3 | | rod | | | | | | |
| Comparative | Ag plate | Cu rod | Non-rotation | 1H | 200 | X | ◯ | X |
| Example 4 | | | | | | | | |
| Comparative | Ag plate | Ag plate | Non-rotation | 3 min | 15-150 | XX | ⊚ | XX |
| Example 5 | | | | | | | | |

In the Table, a symbol ⊚ denotes very good, a symbol ◯ denotes good, a symbol X denotes bad, a symbol XX denotes very poor. However, in the case of growth of particles, the symbol ⊚ denotes very fast growth, and the symbol X denotes no growth.

As can be seen from Table 1, when Examples 5 to 7 are compared with Example 1, size of silver nanoparticles was significantly reduced from 100 nm to 50 nm. It appeared that changes in the size of the silver nanoparticles had been due to rotation of the cathode.

In particular, as can be seen from Examples 5 to 7, when the carbon cathode rod was made to rotate at least 1,750 rpm, silver nanoparticles of a uniform circular shape were able to be obtained in average size of 50 nm.

Through the above experiments, a rotating condition of the rotational cathode is to rotate at least 1,750 rpm in order to obtain silver nanoparticles of a uniform circular shape. Even in the case that the rotational cathode is made to rotate at 6,000 rpm or higher exceeding 3,000 rpm, an average size of particles is maintained at 50 nm or so but does not become small any longer.

When viewed through experiment of Comparative Example 5 in which both anode and cathode electrodes were identically made of a silver plate, respectively, silver particles started to grow immediately before elapse of long time during reaction, to thereby cause a phenomenon of increasing size of particles to occur. As a result, it could be seen that Comparative Example 5 was inappropriate for mass-production of continuously producing nanoparticles for a long time. Further, even in the case that a Ag rod was used as a cathode as illustrated in Comparative Example 1, an identical result was obtained.

Moreover, it could be seen that phenomena of increasing the particles increased and deteriorating uniformity of the particles were accompanied when the silver particles began to grow. Therefore, it was confirmed that a technique of constituting an anode and a cathode using the same material as that of metal particles to be obtained as proposed in Korean Patent Laid-open Publication No. 10-2004-105914 was inappropriate for the mass-production technique of mass-producing silver nanoparticles.

In addition, in the case that any one of carbon, stainless steel (SUS 316), and iron (Fe) was used as a cathode material, growth of silver nanoparticles did not occur and silver crystallines were not educed on the surface of the cathode rod. The remaining materials used as the cathode material caused silver crystallines to be educed on the surface of the cathode rod together with causing the silver particles to grow. Here size of the silver nanoparticles was larger than 100 m, and uniformity of particles was not good.

It has been described to produce silver nanoparticles, in the above-described embodiments, but it is also possible to apply one of the other metal materials other than silver for an anode material, in order to obtain nanoparticles of the other metal other than silver.

As described above, the present invention has been described with respect to particularly preferred embodiments. However, the present invention is not limited to the above embodiments, and it is possible for one who has an ordinary skill in the art to make various modifications and variations, without departing off the spirit of the present invention. Thus, the protective scope of the present invention is not defined within the detailed description thereof but is defined by the claims to be described later and the technical spirit of the present invention.

### INDUSTRIAL APPLICABILITY

The silver nanoparticles can be uniformly mass-produced in a simple process and eco-friendly according to the present invention. Accordingly, the silver nanoparticles that are produced according to the present invention can be widely used for most applications such as medical care, clothing, cosmetics, catalysts, electrode materials, and electronic materials. In particular, the silver nanoparticles are suitable for a conductive ink material that is used when a conductive pattern is formed on an insulating film for example.

1. A method of producing silver nanoparticles using an electrolysis, the silver nanoparticles producing method comprising the steps of:
dissolving a reducing agent and an electrolyte into water in a reaction vessel to thereby prepare an electrolytic solution;
placing a cathode that is made of a material different from that of silver nanoparticles to be obtained in the electrolytic solution so as to rotate in the reaction vessel, and placing at least one anode made of silver (Ag) at a certain distance from the cathode;
ionizing the silver at the anode by the electrolysis in which direct-current (DC) power is applied between the cathode and the anode while rotating the cathode; and
reducing the silver ions by the reducing agent to thereby form the silver nanoparticles.

2. The method of claim 1, wherein the cathode is placed at a substantially central portion of the reaction vessel.

3. The method of claim 1, wherein the electrolytic solution is stirred by an agitator.

4. The method of claim 1, wherein the cathode is made of any one of carbon, stainless steel (SUS 316), and iron (Fe).

5. The method of claim 1, wherein the cathode is formed of an inverted truncated cone structure, a rod shape, or an elliptical rod shape.

6. The method of claim 1, wherein the anode is formed of a plate shape or a rod shape.

7. The method of claim 3, wherein a rotation direction of the agitator is set to be the opposite direction to that of the cathode.

8. The method of claim 1, wherein the cathode is made to rotate in a range from 1,750 rpm to 6,000 rpm.

9. The silver nanoparticles producing method of claim 1, wherein the reducing agent is an organic ion reducing agent, and the electrolyte is citric acid or amino acid.

10. An apparatus for producing silver nanoparticles using an electrolysis, the silver nanoparticles producing apparatus comprising:
a cathode that is placed in an electrolytic solution within a reaction vessel so as to rotate in the reaction vessel and made of a material different from that of silver nanoparticles to be obtained;
at least one anode made of silver at a certain distance from the cathode; and
an electrode support housing that supports the cathode and the anode in an insulating form, and that has a negative terminal and a positive terminal that are externally exposed so that electric power is applied between the cathode and the anode for performing the electrolysis.

11. The apparatus according to claim 10, wherein the cathode is placed at a substantially central portion of the reaction vessel.

12. The apparatus according to claim 10,
further comprising an electromagnetic driven agitator for agitating the electrolytic solution.

13. The apparatus according to claim 10, wherein a rotation direction of the agitator is set to be the opposite direction to that of the cathode.

14. The apparatus according to claim 10, wherein the cathode is made of any one of carbon, stainless steel (SUS 316), and iron (Fe).

15. The apparatus according to claim 10, wherein the cathode is made to rotate in a range from 1,750 rpm to 6,000 rpm.

16. The method according to claim 1, wherein the water is pure water or ultrapure water (DI-Water; DeIonized-water).

17. The apparatus according to claim 10, wherein water used in the electrolytic solution is pure water or ultrapure water (DI-water; DeIonized-water).
